(19) United States
(12) Patent Application Publication
(10) Pub. No.: US 2009/0210822 A1
(43) Pub. Date: Aug. 20, 2009

(54) LOCATING MEETING USERS

(75) Inventor: Christopher Schindler, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/033,004

(22) Filed: Feb. 18, 2008

(51) Int. Cl. G06F 3/048; G06F 15/16

(52) U.S. Cl. 715/810; 709/206

(57) ABSTRACT

The disclosed communications architecture allows meeting organizers to automatically search and find meeting invitees or other target users using all known, discoverable, and available communications channels such as the telephone, text messaging, SMS (short message service), MMS (multimedia messaging service), single-purpose applications (e.g., gadgets), and email, for example, to at least notify the invitees of the meeting. The meeting organizer can initiate the automatic searches for invitees who may have missed the session start, or who may not have responded to participating in the meeting prior to meeting start, for example. Optionally, contacted meeting invitees can be easily joined into a meeting using web conferencing or other conference services (e.g., call) so the meeting can get started. The meeting organizer is then updated on the search request status and any invitee responses.

### BACKGROUND

Meetings are a productive means for communicating intents and goals to meeting participants, whether the meeting be virtual (e.g., a web conference, conference call), in a real conference room, or a combination of both virtual and real. However, organizing the meeting and getting all the desired invitees to the meeting it typically time-consuming and a headache for the organizer. For example, mustering key people for the meeting is oftentimes problematic due to travel, other meetings, or temporarily out-of-the-office, and the variety of communication modes for connecting to the meeting. In other words, the meeting organizer can waste an inordinate amount of time trying to contact missing invitees via phone calls, text messaging, email, or otherwise track down the invitees. Thus, organizer frustration should be minimized and employee productivity improved with more effective and efficient techniques for organizing real and/or virtual meetings.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed communications architecture allows meeting organizers to automatically reach out and find participants (invitees) to meetings or sessions using all known and discoverable, and available communications channels such as the telephone, text messaging, (e.g., instant messaging) SMS (short message service), MMS (multimedia messaging service), single-purpose applications (e.g., gadgets), and email, for example, to at least notify the invitees of the meeting, and optionally, bring the invitees into the meeting.

The meeting organizer can initiate automatic searches for invitees who may have missed the session start, or who may not have responded to participating in the meeting prior to meeting start, for example. Contacted meeting invitees can be quickly brought into a meeting using web conferencing, or other conference services (e.g., call) so the meeting can get started as quickly as possible. The automated person search service uses all available communication means to contact the invitee and update the meeting organizer on the search request status and any invitee responses.

The communications architecture finds particular implementation in combination with personal information manager (PIM) applications that employ meeting setup, tracking, contact lists, email, calendars, and so on. Meetings covered by this feature will range from small to large, informal to formal, and take into account social hierarchies.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented communications system for searching session invitees.

FIG. 2 illustrates an alternative communications system for searching session invitees and receiving invitee feedback.

FIG. 3 illustrates a system with components of the disclosed communications architecture embodied as a PIM application.

FIG. 4 illustrates a flow diagram for an exemplary implementation for invitee search and response.

FIG. 5 illustrates an exemplary user interface tracking page for the tracking of meeting information of the meeting.

FIG. 6 illustrates a computer-implemented communications method in accordance with the disclosed architecture.

FIG. 7 illustrates a method of automated search for meeting invitees.

FIG. 8 illustrates a method of pushing a search based on session state.

FIG. 9 illustrates a block diagram of a computing system operable to execute invitee search for a meeting in accordance with the disclosed architecture.

FIG. 10 illustrates a schematic block diagram of an exemplary computing environment that facilitates invitee searching over available communication channels.

### DETAILED DESCRIPTION

The disclosed architecture includes a search mechanism for finding meeting users (e.g., invitees) using communications channels that can be discovered at any point in time, notifying the users (e.g., invitees), receiving response information back based on the search and/or target user response, and posting the results to a meeting organizer and/or other user. The search functionality can be a pull system where the organizer initiates the search and/or a push system where the system monitors attendance to the meeting and auto-searches for those invitees not in attendance.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

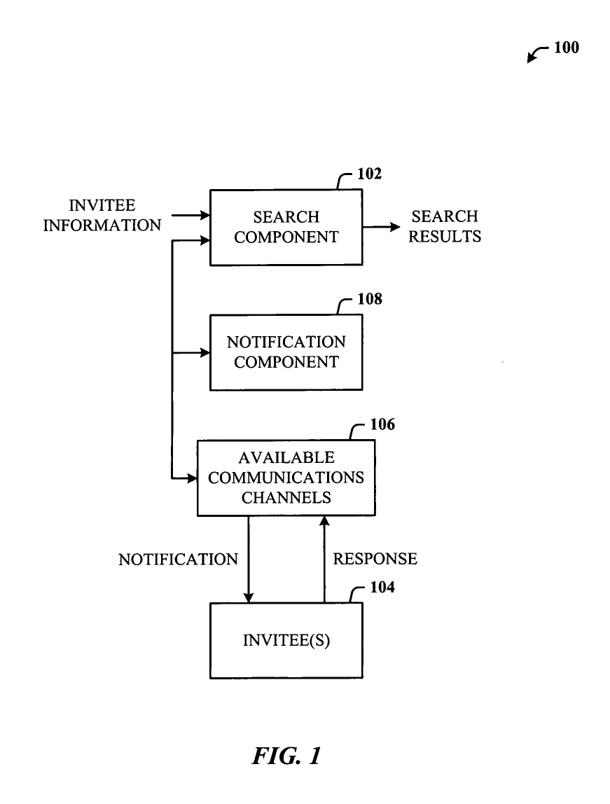

FIG. 1 illustrates a computer-implemented communications system 100 for searching session invitees. The system 100 includes a search component 102 for automatically performing a search for invitee(s) 104 to a communications session via available communications channels 106. The available communications channels 106 can be wire/wireless digital and analog communications technologies, including but not limited to, text messaging (e.g., instant messaging), email, SMS (short message service), MMS (multimedia message service), SPAs (single-purpose applications such as desktop gadgets, sidebar gadget, collaboration widgets, etc.), or phone calls.

Availability of the channels 106 can be related to the ability to connect to the channels due to connection failure, bandwidth considerations, related to presence information as to whether the invitee is offline, busy, available, away, etc., and other criteria. For example, the invitee(s) 104 may not have a cell phone; thus, attempted notification will discover this and, alternatively, attempt communications via a landline phone (e.g., PSTN-public switched telephone network) and/or an IP-phone (via voice over IP (VoIP)), for example.

The system 100 also includes a notification component 108 for sending a notification of the session to the invitee(s) 104 via the available communications channels 106 as part of the search. The notification can include a custom message created by a requester that initiated the search (the session organizer) to the invitee(s) 104, and a response to the custom message from the invitee(s) 104 is received via one or more of the available communications channels 106.

The process for communicating the notification to the invitee(s) 104 can be based on invitee profile information, for example, where the contact information for the invitee indicates that the invitee should first be contacted via a cell phone, and if that fails, next, use email, and if that fails, call home, etc. The invitee can also impose rules that restrict communications access, for example, indicate communications should never be made to a home number. In yet another implementation, the session organizer can be given authority (based on one or more enterprise rules) to override the invitee rules based on criteria (e.g., importance) in contacting the invitee. The notification process can also include a broadcast mode where all available channels are used concurrently to send the notification to the invitee(s) 104.

The notification process can include repeating the notification on a periodic basis (e.g., every five minutes) based on timeouts received on a channel. For example, if the landline phone channel indicates that the line is busy, indicating that the invitee can be reached, if persistent, the notification can be repeatedly transmitted on the busy channel. Moreover, the repetitive period can be reduced to accelerate transmission of the notification as time gets closer to the session start time, and/or based on the length of time the channel is busy. For example, the longer the invitee is on the line, the more likely the call will end as time goes on.

Business rules employed can include, but are not limited to, the search functionality (the searcher) only enabled for “meeting” appointment type (as defined by one or more invitees), the searcher is enabled pre-meeting and during meeting, changes in a participant's connection status is reflected in the UI in near realtime, managing 3^{rd} party invitees (outside the company), if no contact information can be found in the personal contact list the contact will be listed as “Not enabled”, and no single organizer can issue more than one request per target user.

Other rules include issuing search request timeouts after five minutes and reporting back “Time out”, providing granular feedback on contact status such as like “ringing”, “contacted”, etc., the searcher is only available to the organizer and the organizer delegates, application voice access input into the “find” or “search” field indicating “will be late”, etc., and searcher application functions as or with the same permissions as the meeting organizer. A “cancel” selection will prevent further contact attempts, but will not stop in-progress voice phone calls. A custom message applies to each checkbox selected when the Search action is initiated. If an access personal contacts checkbox has been flagged, the organizer's (or requestor's) personal contact list will be queried and contact data attempted to be retrieved. In another implementation, the invitee can respond with a customized response.

The search component 102 and notification component 108 can be employed as part of a PIM (personal information manager) application, for example, where meetings, calendars, contact lists and communications modes (e.g., email, messaging, etc.) are facilitated.

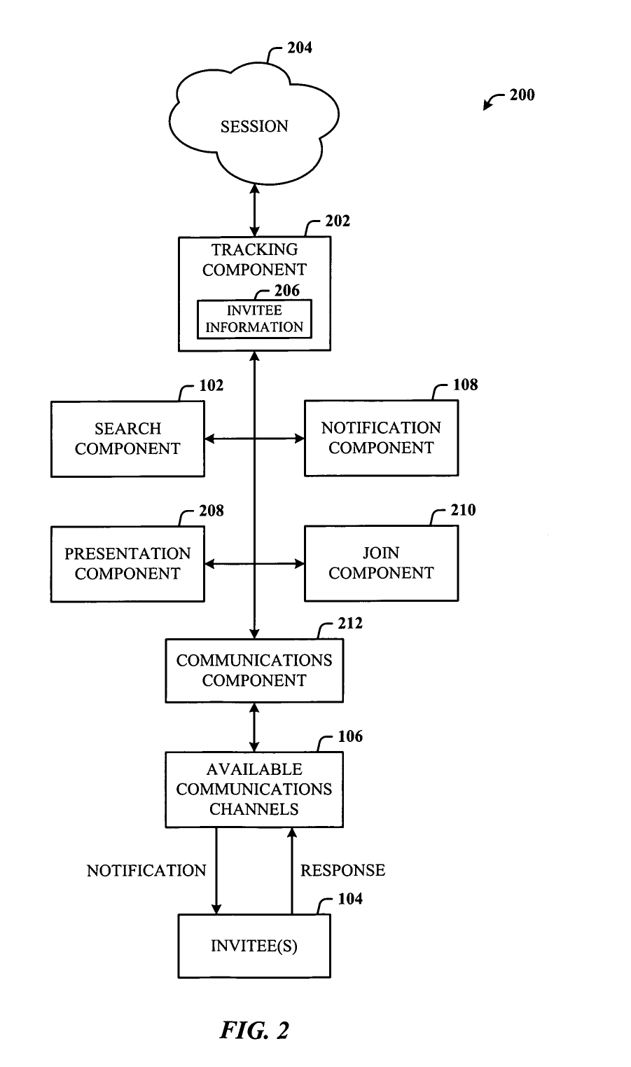

FIG. 2 illustrates an alternative communications system 200 for searching session invitees and receiving invitee feedback. The system 200 includes the search component 102 for performing a search for invitee(s) 104 and notification component 108 for facilitating communications to the invitee(s) 104 over the available communications channels 106. The system 200 can also include a tracking component 202 for tracking attendance state of the invitee(s) 104 relative to a communications session 204 based on invitee information 206, and making the attendance state available for presentation by a presentation component 208 for user (organizer or other invitee) viewing and interaction. The attendance state can include if the invitee is a required attendee, optional attendee, has accepted the invitation to attend the session 204, and the connection state (e.g., unknown, in room, conference call, web conference access, etc.) for connecting to the session 204. The notification component 108 receives feedback information from the invitee that is presented to an initiator of the search.

Optionally, the system 200 can further employ a join component 210 that facilitates joining the invitee(s) 104 to the session 204 in response to the notification. Alternatively, the invitee(s) 104 can respond to the requester (search initiator or session organizer) notification by indicating inability to attend, or the invitee will attend, and then joins the session 204.

The search component 102, notification component 108, tracking component 202, and presentation component 208 can be employed as part of a PIM application, for example, where meetings, calendars, contact lists, user and event tracking, and communications modes (e.g., email, messaging, etc.) are provided. Optionally, the join component 210 can also be provided, although this is not a necessary component.

In an alternative implementation, the tracking component 202 tracks session state of the invitees 104 relative to the communications session 204 and provides a mechanism for selecting one or more of the invitees 104 for a search. The search component 102 automatically performs the search for the one or more of the invitees 104 via the available communications channels 106. The notification component 108 sends session information about the session 204 to the one or more invitees 104 as part of the search and via the available communications channels 106.

The session information can include a default message and/or a custom message from a session organizer. A response to the session information can then be received from the one or more invitees 104 via one or more of the available communications channels 106.

The presentation component 208 can present via a user interface, inter alia, session invitee identifiers (invitee names, location names, email addresses, etc.), session location information, invitee response information, invitee connection information, and search objects (e.g., a search button) for initiating and stopping searches for the one or more invitees 104.

A communications component 212 facilitates communications via the available communications channels 106 to the invitee(s) 104 and the invitee systems and devices. For example, the communications component 212 can include an email application for communicating via email, a text messaging application for text messaging, a browser for web access to web conferencing, a mobile application for communicating voice signals (e.g., VoIP), and so on.

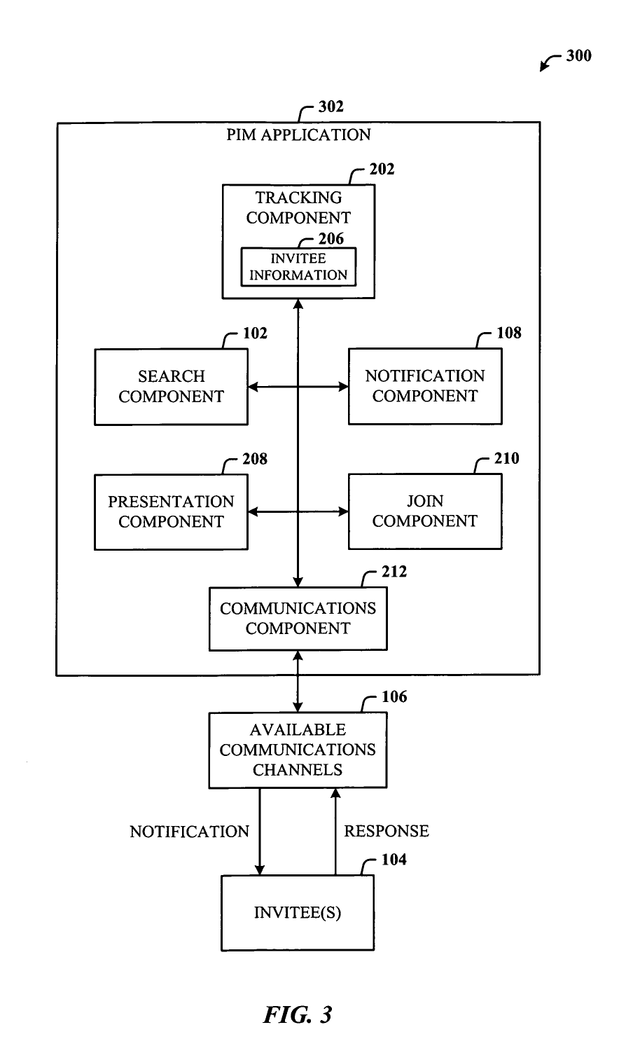

FIG. 3 illustrates a system 300 with components of the disclosed communications architecture embodied as a PIM application 302. The PIM application 302 is a client application delivered separately as a standalone application or part of an office suite of applications that facilitates finding invitees via the office applications (e.g., a word processor).

In the context of the PIM 302, the tracking component 202 can function to receive the names of the invitees to the meeting (session) as entered by the session organizer, send the meeting information (e.g., time, date, duration, meeting information etc.) to the invitees via the communications component 212 (e.g., email program).

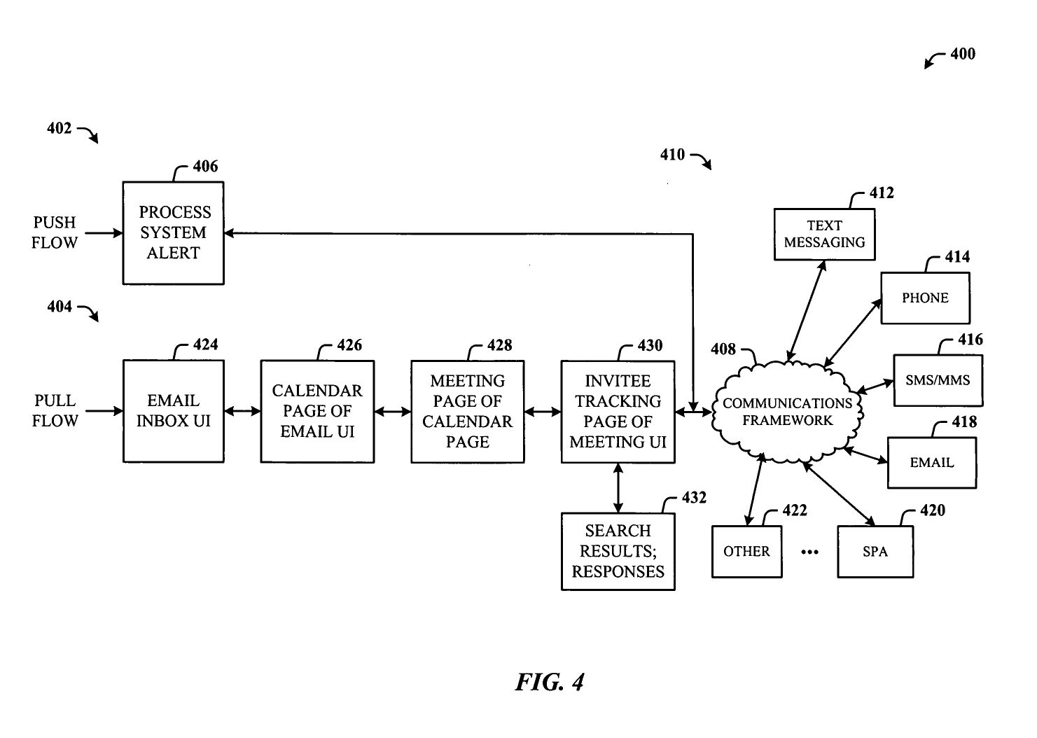

FIG. 4 illustrates a flow diagram 400 for an exemplary implementation for invitee search and response. Generally, the organizer (or an organizer delegate), for a given meeting is able to view participants, view invitee response, initiate a search (a find) request, view status of the search request, and view an invitee response. The diagram shows a push flow 402 and a pull flow 404. In the push flow 402, the system receives a system alert 406 that an invitee is not present in a meeting. The system than automatically initiates a search for the user via a communications framework 408 that include communications technology for contacting the user via multiple different communications channels 410, for example, a text messaging system 412, a phone system 414 (e.g., cellular, landline, IP-based), an SMS/MMS systems 416, email system 418, SPA technology 420 (e.g., desktop gadget, sidebar gadgets, collaborative widgets, etc.), and other communication technologies and systems 422 (e.g., GPS-global positioning system, triangulation, signal strengths, video capture systems for recognition, voice recognition, etc.). With respect to SPAs, the notification can be pushed to a gadget server (or system) and inserted into the gadget for presentation to the invitee.

In other words, the other systems 422 can include or interact with a wide variety of sensing systems that can sense the user, and hence, the user location. For example, if the user (invitee of the second virtual meeting) is currently involved in a real (physical) conference room of a first meeting that employs panoramic and/or 360-degree cameras, the camera systems can process images of the first meeting attendees, recognition process the images, and match the processed images to users to, ultimately, determine who is in attendance. This location information can then be returned as the invitee response to the organizer of the second meeting without the invitee interaction.

Once the location of the invitee is determined to be in the first meeting, the organizer for the second meeting can signal the user at the real conference room using the conference room phone, for example, or a computer display operational in the real conference room of the first meeting. The invitee of the second virtual meeting (also the attendee of the first meeting) can then respond to the organizer, if desired. Carrying this example further, the attendee in the real conference room could then join the virtual meeting via a web conference, thereby participating in both meetings.

The other systems 422 also include conventional presence systems that can input presence information into the response, for example. In other words, the response to the organizer search can be “busy”, “away”, etc., or other commonly-used presence indications (e.g., asleep, offline, etc.).

The pull flow 404 with the meeting organizer (or delegate with adequate permission) accessing an email program UI 424 to locate an invitee to a meeting (virtual or real). The organizer can then access a calendar page 426 of the email UI 424 to access specific meeting or appointment information. When selecting the meeting or appointment of the calendar, a meeting page 428 is launched from the calendar page 426. The organizer can then select tracking functionality of the meeting page 428 to expose a tracking page 430. The tracking page 430 can show all invitees and the current attendance state, such as accepted, not accepted, etc. In the tracking page 430, the organizer can select invitees for searching. This can be prior to meeting start, after the meeting starts, and/or after the meeting ends, for example. Moreover, the capability for the organizer to view if an invitee has enabled reminders can be provided.

In one implementation, the architecture automatically attempts to discover and utilize all available communications channels to reach an invitee that the organizer has searched. In an alternative implementation, the organizer can select one or more of the communications channels to use.

Invitee responses can be received via any one or more of the communications channels 410 and via channels different than over which the request was received. For example, the organizer can receive the response via email for a request that reached the invitee via a phone call message. The response can also be received via text messaging, in addition to email, for example. The organizer can be notified of invitee response and updates via toast (a small informational window for notification of an event), popup panels and/or virtual indicators, for example, that indicate invitee acceptance, decline, or no response, to name a few.

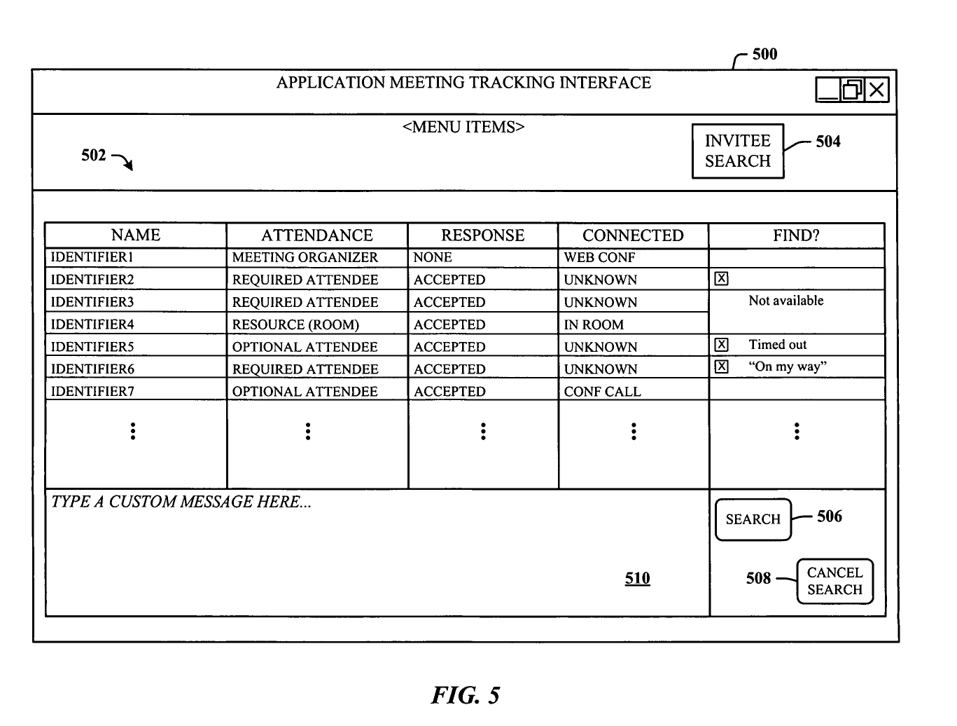

FIG. 5 illustrates an exemplary user interface tracking page 500 for the tracking of meeting information of the meeting. Tracking information 502 can include identifier information (NAME) for the meeting such as invitee names and conference room name/location. The identifiers can also be email addresses, for example. The tracking information 502 can also include attendance information (ATTENDANCE) such as meeting organizer, required attendee, optional attendee, resource (room), etc. The tracking information 502 can further include response information (RESPONSE) that indicates if invitees have accepted attendance to the meeting, no responded, or declined, for example. The tracking information 502 can further include connection information (CONNECTED) that indicates the communications channel currently employed by invitees to connect to the meeting. The connection information includes unknown, web conference, conference call, in room, and so on.

A FIND column can be exposed when the organizer selects an Invitee Search object 504, which allows the organizer to select invitees for searching (or finding). Here, invitees associated with names Identifier2, Identifier5, and Identifier6 are selected for finding. The organizer can then select a Search button 506 to start the search. The current state of the tracking interface 500 is in-process. This is represented by the invitee Identifier1 having yet to receive a response (e.g., timed out), the response for invitee Identifier5 is “timed out”, and the response for invitee Identifier6 is “on my way”. The search can be cancelled by selecting a Cancel Search button 508. If the request is cancelled and the target user (e.g., invitee) is already interacting with the system, the system is aware of the cancellation and can inform the target user if this. A custom message field 510 allows the organizer to insert a custom message for sending to the invitee(s) in addition to the basic meeting notification. For example, a default notification can be “meeting has started”, but the custom message can indicate “just got started; you are up in 10 minutes”.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

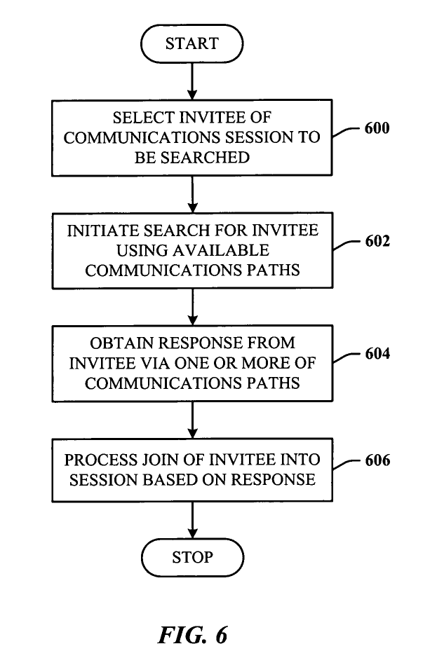

FIG. 6 illustrates a computer-implemented communications method in accordance with the disclosed architecture. At 600, an invitee of a communications session is selected to be searched. At 602, a search is initiated for the invitee using available communications paths. At 604, a response is obtained from the invitee via one or more of the communication paths. At 606, join of the invitee into the session is processed based on the response. The join process can be that the user is joined into the session or not joined, in which case, the invitee can send a response, or the request times out and a timeout response is returned to the organizer.

An alternative approach includes the application using information form a PIM or other status indicator for intelligently choosing which communications path to route the search, or to notify the searcher (initiator, inviter, or similar descriptor for a user who initiates the search) that a user is out-of-the office, for example.

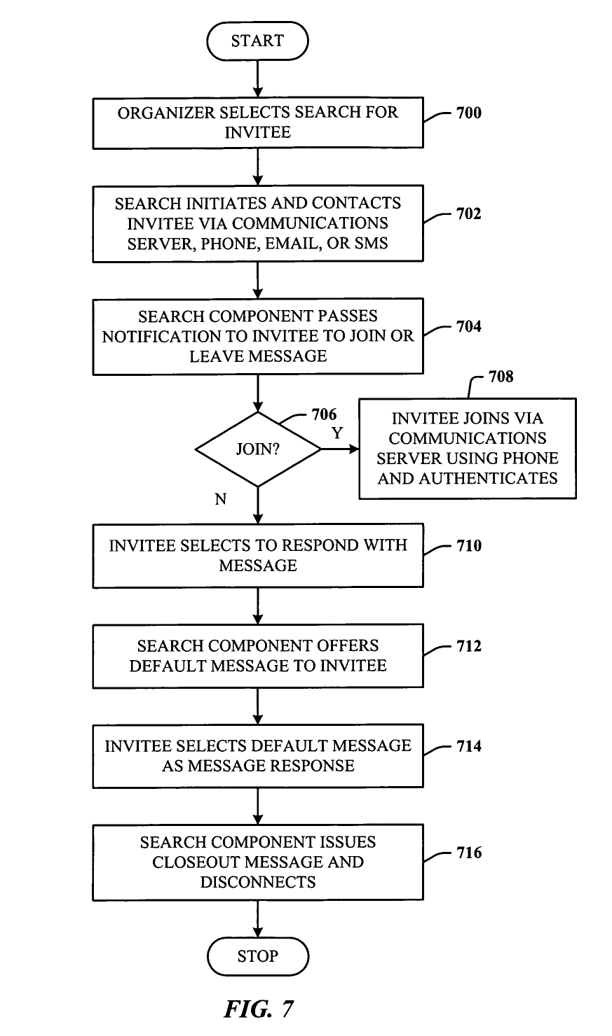

FIG. 7 illustrates a method of automated search for meeting invitees. At 700, the meeting organizer selects to search for a meeting invitee. At 702, the search component initiates the search and contacts the invitee via a communications server, phone, email, and/or SMS. At 704, the search component passes a notification to the invitee such as “X is asking you to join their meeting currently in-progress. Leave message or join now”. At 706, the search component checks for the invitee selection to join. If so, at 708, the invitee joins by connecting via the communications server using a phone. The join process can include authentication (optional) of the invitee and the invitee joins into the meeting. At 710, the invitee selects to respond with message. At 712, a default message is offered to the invitee. At 714, the invitee selects the default message as the message response. At 716, the search process issues a closing remark (e.g., “thank you”) and closes out the communications channel.

Although the above method indicates that the organizer initiates the search, it is within contemplation that an alternative implementation allows a different user to initiate the search (e.g., with the appropriate permissions). In yet another implementation, a target user who receives a request can forward the request to a delegate user who can then attends on behalf of the target user. The forwarding process can allow the target user to include a message as part of the forwarded request. The act of forwarding can also be communicated to the initiator. Additionally, the initiator can impose restrictions that do not allow forwarding, for example.

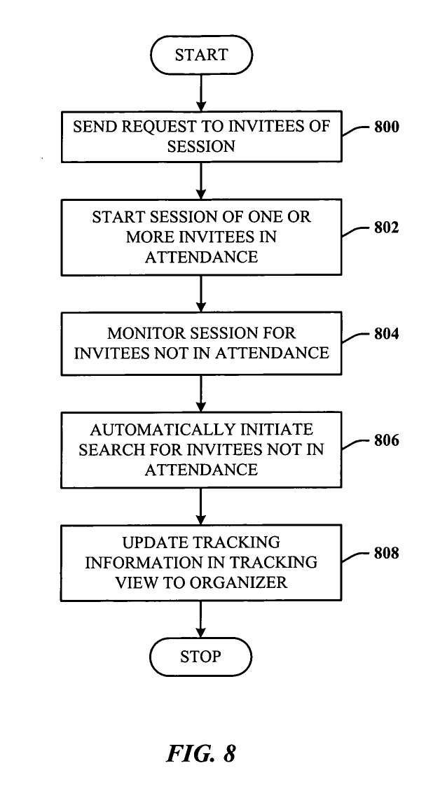

FIG. 8 illustrates a method of pushing a search based on session state. At 800, requests are sent to invitees of a session. At 802, the session is started having one or more of the invitees in attendance. At 804, the session is monitored for invitee attendance. At 806, a search is automatically initiated for invitees not in attendance. At 808, tracking information is updated in a tracking view based on response to the search.

The auto-search push functionality can be initiated, not initiated, and terminated based on a number of criteria. For example, there may be no need to auto-search if the session is nearly over, if a session speaker has already presented, or if certain invitees are not in attendance, etc. Contrariwise, an auto-search can be initiated based on a specific invitee (e.g., principal) not in attendance to indicate to the other invitees not in attendance that attendance is not needed since the principal invitee is not in session.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

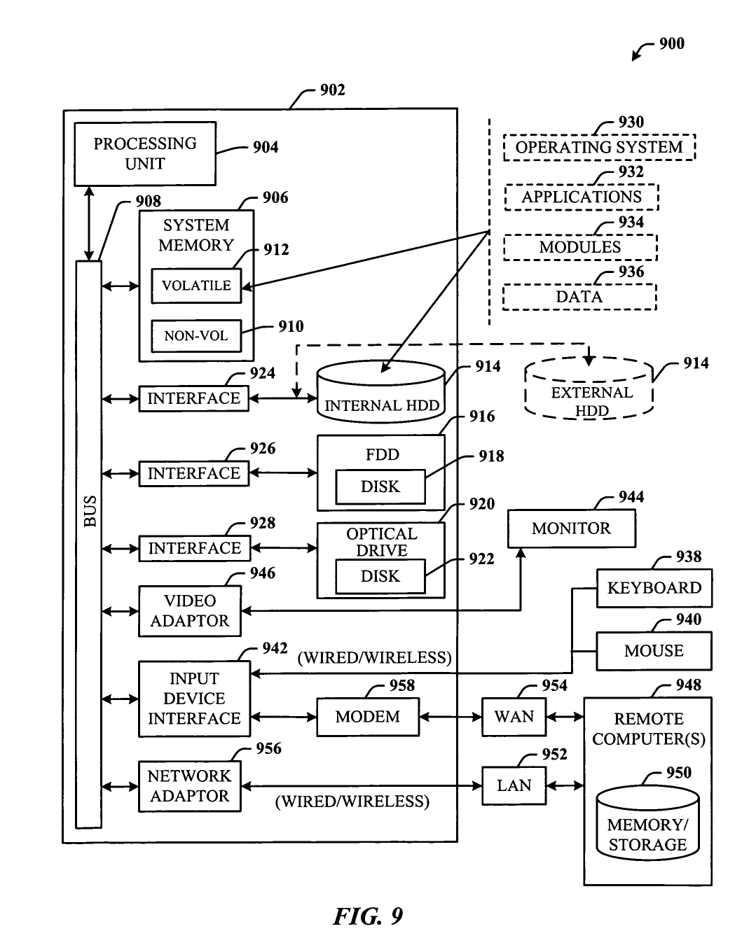

Referring now to FIG. 9, there is illustrated a block diagram of a computing system 900 operable to execute invitee search for a meeting in accordance with the disclosed architecture. In order to provide additional context for various aspects thereof, FIG. 9 and the following discussion are intended to provide a brief, general description of a suitable computing system 900 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 9, the exemplary computing system 900 for implementing various aspects includes a computer 902 having a processing unit 904, a system memory 906 and a system bus 908. The system bus 908 provides an interface for system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 can include non-volatile memory (NON-VOL) 910 and/or volatile memory 912 (e.g., random access memory (RAM)). A basic input/output system (BIOS) can be stored in the non-volatile memory 910 (e.g., ROM, EPROM, EEPROM, etc.), which BIOS are the basic routines that help to transfer information between elements within the computer 902, such as during start-up. The volatile memory 912 can also include a high-speed RAM such as static RAM for caching data.

The computer 902 further includes an internal hard disk drive (HDD) 914 (e.g., EIDE, SATA), which internal HDD 914 may also be configured for external use in a suitable chassis, a magnetic floppy disk drive (FDD) 916, (e.g., to read from or write to a removable diskette 918) and an optical disk drive 920, (e.g., reading a CD-ROM disk 922 or, to read from or write to other high capacity optical media such as a DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 912, including an operating system 930, one or more application programs 932, other program modules 934, and program data 936. The one or more application programs 932, other program modules 934, and program data 936 can include the search component 102, notification component 108, tracking component 202, session 204, invitee information 206, presentation component 208, join component 210, communications component 212, PIM application 302, system alert functionality 406, email inbox UI 424, calendar page 426, meeting page 428, tracking page 430, and tracking interface 500, for example.

All or portions of the operating system, applications, modules, and/or data can also be cached in the volatile memory 912. It is to be appreciated that the disclosed architecture can be implemented with various commercially available operating systems or combinations of operating systems.

A user can enter commands and information into the computer 902 through one or more wire/wireless input devices, for example, a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, etc.

A monitor 944 or other type of display device is also connected to the system bus 908 via an interface, such as a video adaptor 946. In addition to the monitor 944, a computer typically includes other peripheral output devices (not shown), such as speakers, printers, etc.

The computer 902 may operate in a networked environment using logical connections via wire and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, is connected to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

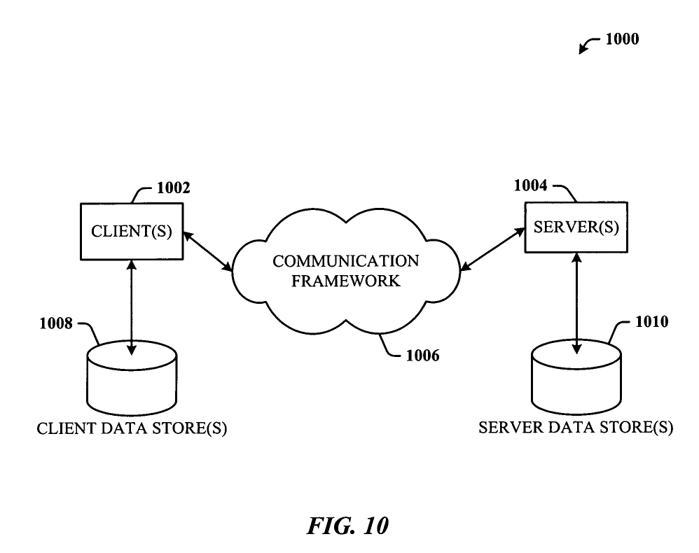

Referring now to FIG. 10, there is illustrated a schematic block diagram of an exemplary computing environment 1000 that facilitates invitee searching over available communication channels. The environment 1000 includes one or more client(s) 1002. The client(s) 1002 can be hardware and/or software (e.g., threads, processes, computing devices). The client(s) 1002 can house cookie(s) and/or associated contextual information, for example.

The environment 1000 also includes one or more server(s) 1004. The server(s) 1004 can also be hardware and/or software (e.g., threads, processes, computing devices). The servers 1004 can house threads to perform transformations by employing the architecture, for example. One possible communication between a client 1002 and a server 1004 can be in the form of a data packet adapted to be transmitted between two or more computer processes. The data packet may include a cookie and/or associated contextual information, for example. The environment 1000 includes a communication framework 1006 (e.g., a global communication network such as the Internet) that can be employed to facilitate communications between the client(s) 1002 and the server(s) 1004.

Communications can be facilitated via a wire (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

The server(s) 1004 can include communications servers, web conferencing servers, conference call servers, web-based collaboration servers, communications channels servers that facilitate communications via the search functionality via the communications framework 1006 (e.g., cellular carriers, IP networks, landline phone networks, etc.). The client(s) 1002 can include the PIM application 302, and other client applications (e.g., office applications) that can use the disclosed search architecture to find users.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented communications system, comprising:
a search component for automatically performing a search for an invitee to a communications session via available communications channels; and
a notification component for sending a notification of the session to the invitee via the available communications channels as part of the search.

2. The system of claim 1, wherein the notification includes a custom message from a requestor that initiated the search to the invitee, and a response to the custom message from the invitee is received via one or more of the available communications channels.

3. The system of claim 1, wherein the available communications channels include at least one of text messaging, email, SMS, MMS, single-purpose application, or a phone call.

4. The system of claim 1, further comprising a tracking component for tracking attendance state of the invitee relative to the communications session and providing the attendance state for presentation.

5. The system of claim 4, wherein the notification component receives feedback information related to the invitee, the feedback information presented to an initiator of the search.

6. The system of claim 4, wherein the search component, notification component, and tracking component are part of a personal information manager application.

7. The system of claim 1, wherein the invitee joins the session in response to the notification or sends a response to a requestor of the search.

8. A computer-implemented communications system, comprising:
a tracking component for tracking session state of invitees relative to a communications session and selecting one or more of the invitees for a search;
a search component for automatically performing the search for the one or more of the invitees via available communications channels; and
a notification component for sending session information about the session to the one or more invitees as part of the search via the available communications channels.

9. The system of claim 8, wherein the session information includes a default message or a custom message from a session organizer, and a response to the session information is received from the one or more invitees via one or more of the available communications channels.

10. The system of claim 8, further comprising a presentation component for presenting session invitee identifiers, session location information, invitee response information, invitee connection information, and search objects for initiating and stopping searches for the one or more invitees.

11. The system of claim 8, wherein the search component, notification component, and tracking component are part of a personal information manager application.

12. The system of claim 8, wherein the invitee joins the session in response to the notification or sends a response to a requester of the search.

13. A computer-implemented communications method, comprising:
selecting an invitee of a communications session to be searched;
initiating a search for the invitee using available communications paths; and
obtaining a response from the invitee via one or more of the communication paths.

14. The method of claim 13, further comprising creating and sending a custom message to the invitee as part of the search.

15. The method of claim 13, further comprising updating a tracking interface for viewing based on the response.

16. The method of claim 13, further comprising sending a request to the invitee as part of the search and joining the invitee into the session in response to receiving the request.

17. The method of claim 16, further comprising joining the session via a web conference or a conference call.

18. The method of claim 13, further comprising automatically contacting the invitee via the available communication channels and presenting one or more invitee responses via a tracking interface.

19. The method of claim 13, further comprising exposing a user-selectable search interface as part of a tracking interface, and searching a contact list as part of the search.

20. The method of claim 13, further comprising actively monitoring attendance of the session, automatically initiating a search for invitees not in attendance, and updating tracking information based on responses to the search.
